(19) United States
(12) Patent Application Publication
(10) Pub. No.: US 2024/0295896 A1
(43) Pub. Date: Sep. 5, 2024

(54) CONTROL CONSOLE FOR A PERSONNEL-LIFTING MACHINE, AND PERSONNEL-LIFTING MACHINE COMPRISING SUCH A CONTROL CONSOLE

(71) Applicant: HAULOTTE GROUP, LORETTE (FR)

(72) Inventors: Sebastian DITTUS, MORNANT (FR); Thierry GRANJON, MESSIMY (FR); Baptiste ROLAND, CUSSET (FR)

(21) Appl. No.: 18/569,929

(22) PCT Filed: Jun. 14, 2022
(86) PCT No.: PCT/EP2022/066198

§ 371 Date: Dec. 13, 2023

(30) Foreign Application Priority Data
Jun. 15, 2021 (FR) FR2106326

(51) Int. Cl. G05G 9/047; B66F 11/04

(52) U.S. Cl. CPC G05G 9/047; B66F 11/044; G05G 2009/04774

(57) ABSTRACT

The present console has a main body the front and rear faces of which are connected by a through-passage closed by lower and upper crosspieces and left-hand and right-hand uprights. A joystick, arranged within the through-passage, extends upwards from the lower crosspiece and, at rest, is tilted rearwards, from bottom up. The front face of the main body includes a flat surface, on which the through-passage emerges, which is tilted rearwards, from the bottom up, and which extends continuously over both the upper crosspiece where the flat surface is provided with a display, on the left-hand upright where it is fitted with push-buttons, and on the lower crosspiece where it runs from the through-passage to the lower edge of the lower crosspiece, this lower edge being set back from the flat surface.

### CROSS-REFERENCE TO RELATED APPLICATIONS

This application is the US national stage of PCT/EP2022/066198, filed Jun. 14, 2022 and designating the United States, which claims the priority of FR 2106326, filed Jun. 15, 2021. The entire contents of each foregoing application are incorporated herein by reference.

### BACKGROUND OF THE INVENTION

### Field of the Invention

The present invention relates to a control console for a personnel-lifting machine.

The invention further relates to a personnel-lifting machine including such a control console.

### Description of the Related Art

Personnel-lifting machines, such as aerial lifts, are machines intended for allowing one or more people to work at height. For this purpose, such machines comprise a work-platform, designed so that one or more people can stand thereon. The platform comprises a floor surrounded by a guardrail. It is supported by a lifting structure that allows the platform to be raised/lowered between a lowered position on the machine frame and a desired work position at height. The personnel-lifting machines can be self-propelled, i.e. motorized, in order to be apt to move autonomously on the ground. In all cases, the platform is associated with a control console, equipped with manually operated control elements enabling an operator to actuate the deployment of the lifting structure and, where appropriate, the movement of the machine on the ground.

The control console is either permanently mounted on the platform, i.e. permanently mounted at the same given location on the platform, usually on the guardrail, being provided so that the operator stands in front of the guardrail when the operator wishes to manipulate the control elements, or removable, e.g., in order to be movable by the operator so that the control console can be hung in different places on the guardrail, e.g. on the front or rear side of the platform. When the control console is removable, it is generally more compact and lightweight than in the case of stationary control consoles. Furthermore, the control console can be provided so that the operator can hold same with one hand and handle the control elements thereof with the other hand, which in particular makes it possible to control the machine from the ground instead of from the platform. In such case, the control console is even more compact and has even lighter weight.

In all cases, it is not always easy for the operator to take over the controls of the control console according to the “logic” of arranging the control elements on the console. Such problems are all the more present when the same operator successively uses different machines for lifting people, more particularly of different sizes and/or types, the respective control consoles of which follow different “logics”. In addition, the location of the control console on the platform is often unsatisfactory in terms of ergonomics when the console is positioned too high with respect to the platform floor: the operator has then to keep his/her elbows bent at 90° and the console limits the operator's field of vision. Moreover, during operation, the control console is often subject to a difficult working environment, especially when the machine is used outdoors. Rainwater and/or dirt from the work-site can thereby tend to accumulate on the control elements arranged on the console, which can lead to a degraded use of the console, or even to malfunctions of the latter.

The goal of the present invention is to propose a new control console reconciling requirements in terms of ergonomics, reliability and lasting service life.

To this end, the subject matter of the invention is a control console for a personnel-lifting machine, said control console including a main body having front and rear faces connected to each other by a through-passage which is closed by both lower and upper crosspieces of the main body, each extending the throughout the width of the main body, and left-hand and right-hand uprights, each extending throughout the height of the main body. The control console includes a joystick which is arranged inside the through-passage, extending upwards from the lower crosspiece, and which, at rest, occupies a rest position in which, when the control console is in use, the joystick is tilted backwards when considering the joystick from bottom to top. The front face of the main body includes a flat surface:
onto which the through-passage emerges,
which, when the control console is in use, is tilted rearwards when considering the flat surface from bottom to top, and
which extends continuously both on the upper crosspiece, where the flat surface is provided with a display, on the left-hand upright, where the flat surface is provided with push-buttons, and on the lower crosspiece, where the flat surface runs from the through-passage to a lower edge of the lower crosspiece, the lower edge being, at least over a portion of the extent thereof between the left-hand and right-hand uprights, set back from the flat surface.

With the control console according to the invention, the joystick of the latter, which is in particular used for controlling the height displacement and, where appropriate, the ground displacement of the lifting machine, is surrounded by the uprights and crosspieces of the main body of the console, which protects the joystick and reduces the risk of the joystick being moved incorrectly. In the rest position, the joystick extends from the lower crosspiece rearwards, which is particularly ergonomic and reinforces safety by advantageously providing that a tilt of the joystick forwards from the rest position thereof raises the platform while a tilt of the joystick backwards from the rest position thereof lowers the platform. In order to actuate functions other than the functions controlled by the joystick, the control console according to the invention is equipped with push-buttons located on the left-hand side of the front face of the main body. In use, the push-buttons are thereby easily and efficiently actuated by the left hand of the operator, especially when the latter holds the joystick using his/her right hand, without the right arm of the operator hindering the actuation of the push-buttons or hiding the left part of the front face of the main body. In the upper part of the front face of the main body, the control console is equipped with a display which, in use, is clearly visible to the operator and provides the latter with information facilitating the taking over and the use of the console by the operator. Moreover, the push-buttons and the display, as well as, where appropriate, other control elements present on the control console are provided on a flat surface of the front face, on which the through-passage where the joystick is arranged comes out, and which extends to a lower edge of the lower crosspiece of the main body, the lower edge being set back from the flat surface. In use, the flat surface is tilted backwards from bottom up, which is ergonomic, while preventing water retention or dirt accumulation on the flat surface and, thereby, on the push-buttons, the display and any other control elements. Thereby, the control console according to the invention proves to be particularly ergonomic, reliable and lasting, being advantageously available in different sizes while keeping the same “logic” of structure and use. Such advantages are potentially reinforced by other aspects of the control console, which will be detailed thereafter.

According to advantageous additional features of the control console according to the invention:
The flat surface includes, on the lower crosspiece, a first region, which is located in vertical alignment with the joystick, and a second region, which connects the first region to the right-hand upright, and the first and second regions of the flat surface are devoid of any control element.
The flat surface is provided, on the upper crosspiece, with an emergency stop button, in particular located to the right of the display.
The front face of the main body has a rim protruding from the flat surface and running over a part of the periphery of the flat surface, in such a way that the edge of the rim, facing forwards, defines a front support plane, set back from which the joystick in the rest position and the push-buttons are arranged.
The rear face of the main body defines a rear support plane, set back from which the joystick is arranged in the rest position.
The left-hand upright is shaped into a handle for the left hand of an operator using the control console.
When the control console is in use, the joystick in the rest position is tilted at 45°, plus or minus 5°, with respect to the vertical.
The lower crosspiece is provided with a connection port, such as a USB port, which is accessible from the front face of the main body and which is arranged on the lower edge of the lower crosspiece, outside said portion of the lower edge.
The control console includes a wrist rest for the right hand of an operator holding the joystick, said wrist rest being arranged in the lower right-hand corner of the through-passage.
The control console further includes a hook for a removable attachment to a guardrail of a platform of the personnel-lifting machine, the hook being arranged on the rear face of the main body, by being rigidly attached to the upper crosspiece.
The control console includes a protective cover, which is flexible and suitable for covering in a removable manner the flat surface, and which is transparent at least in the part thereof that covers the display when the protective cover covers the flat surface.
The protective cover is permanently attached to one of the upper and lower crosspieces and is deployable to the other of the lower and upper crosspieces, with which the protective cover cooperates so as to be reversibly retained.

A further subject matter of the invention is a personnel-lifting machine, including:
a ground support chassis,
a platform suitable for at least one operator standing thereon,
a lifting structure, which supports the platform and which is movably arranged on the chassis so as to raise the platform, to a greater or lesser extent, with respect to the chassis, and
a control console, which is as defined above and which is attached to the platform either permanently or in a removable manner.

According to advantageous additional features of the personnel-lifting machine according to the invention:
The center of the joystick is located between 91 and 95 cm from a floor of the platform when the control console is attached to the platform.

The joystick is designed for:
raising the platform when the joystick is tilted forwards from the rest position thereof, and
lowering the platform when the joystick is tilted backwards from the rest position thereof.

### BRIEF DESCRIPTION OF THE DRAWINGS

The invention will be better understood upon reading the following description, given only as an example and making reference to the drawings, wherein:

FIG. 1 is a view, in elevation, of a personnel-lifting machine according to the invention;

FIG. 2 is a view similar to FIG. 1, showing, at larger scale, a controls console belonging to the machine shown in FIG. 1;

FIGS. 3 and 4 are perspective views of the control console shown alone, along respective directions of observation which are different;

FIG. 5 is a view, in elevation, along the arrow V shown in FIG. 3;

FIG. 6 is a schematic section along the line VI-VI shown in FIG. 5; and

FIG. 7 is an exploded perspective view of certain parts of the control console of the preceding figures.

### DETAILED DESCRIPTION

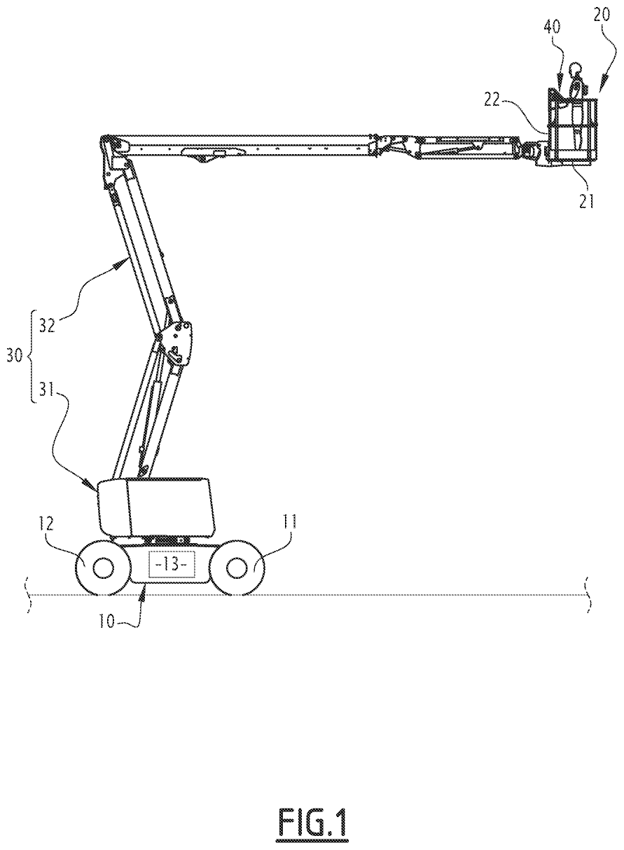

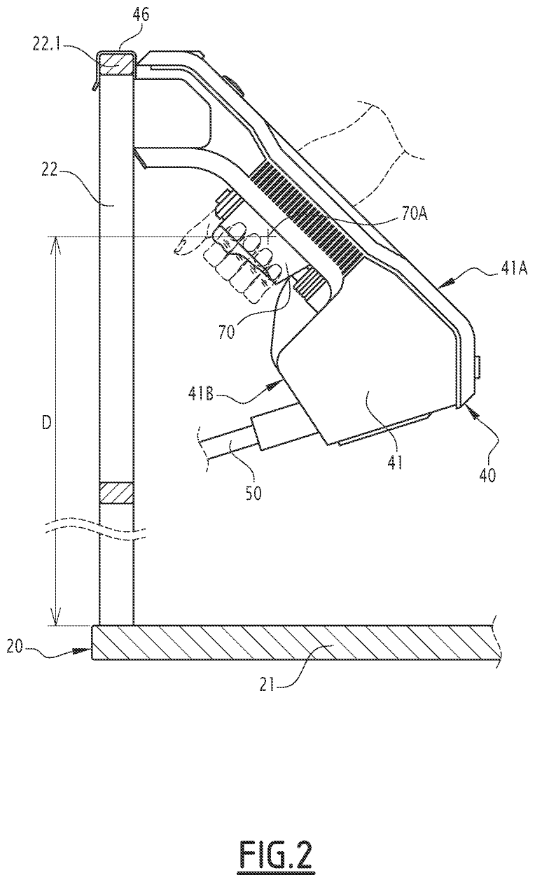

FIGS. 1 and 2 show an aerial lift 1 enabling an operator to reach an area situated at a height in order to carry out work thereon.

As shown in FIG. 1, the aerial lift includes a chassis 10 resting on the ground. The chassis 10 is provided with wheels for being translated on the ground, namely, herein, a pair of rear wheels 11 and a pair of front wheels 12. To enable the chassis 10 to turn with respect to the ground, the wheels of at least one of the two pairs of wheels 11 and 12 are advantageously steering wheels, being inclinable to the left and to the right with respect to an anteroposterior geometric axis of the chassis 10, extending parallel to the ground.

In a variant (not shown), all or some of the rear wheels 11 and of the front wheels 12 can be replaced by tracks for the purpose of translating the chassis 10 on the ground.

More generally, the rear wheels 11 and the front wheels 12 are only examples of ground translation elements equipping the chassis 10.

Whatever the specificities of the ground translation elements, such as the rear 11 and front 12 wheels, the chassis 10 is advantageously provided as a self-propelled vehicle so as to be apt to move autonomously on the ground. To this end, the aerial lift 1 has a motor, which is generally mounted directly on the chassis 10 and which is an internal combustion engine or an electrical or a hybrid motor.

The aerial lift 1 further comprises a platform 20 which is designed so that the operator using the aerial lift can stand on the platform. The platform 20 is thereby designed for receiving on board the operator and, where appropriate, one or more other persons and/or equipment for carrying out work at height. To this end, the platform 20 comprises a floor 21, on which the operator stands and which extends horizontally when the aerial lift is placed on a horizontal ground. The platform 20 also comprises a guardrail 22, which rises from the floor 21 surrounding the platform and which is designed for preventing any fall of persons from platform.

The aerial lift 1 further comprises a lifting structure 30 supporting the platform 20. The lifting structure 30 is arranged on the chassis 10 so as to raise the platform 20 to a greater or lesser extent with respect to the chassis 10. In the example of embodiment considered in FIG. 1, the lifting structure 30 comprises a turret 31 which rests on the chassis 10 and which can rotate with respect to the latter about an axis of rotation extending perpendicularly to the ground, and an arm 32 which connects the turret 31 to the platform 20 and which is deployable so as to move, to a greater or lesser extent, the platform 20 away from the turret 31. The embodiment of the turret 31 is not limiting. Similarly, the embodiment of the arm 32 is not limiting, and, moreover, it should be noted that the term “arm” used herein is understood in a broad sense and thereby corresponds to an elongated mechanical structure, including a plurality of arm elements movable with respect to one another, in particular in an articulated and/or telescopic way, for the purpose of deploying the mechanical structure.

More generally, the embodiment of the lifting structure 30 is not limiting since, by moving parts of the lifting structure with respect to each other and/or with respect to the chassis 10, the positioning of the platform 20 with respect to the chassis 10 is modified accordingly, the displacement of the platform 20 being thereby controlled, by means of the lifting structure 30, by the operator using the lifting platform 1. Thereby, as variants (not shown), the lifting structure 30 can be without the turret 31 and/or can include, or even consist of, a scissor lifting mechanism.

Whatever the specificities of the lifting structure 30, the drive of the latter with respect to the chassis 10 is ensured by drive elements, integrated into the aerial lift 1. Such drive elements, which are known per se in the field, are e.g. mechanical and/or hydraulic and have thermal and/or electrical motorization.

The aerial lift 1 further comprises a control console 40, which is illustrated in detail in FIGS. 2 to 7. As detailed thereafter, the console 40 is provided with various manually actuated control elements enabling the operator to control the drive of the lifting structure 30 and, thereby, to cause in particular, the vertical displacement of the platform 20 with respect to the chassis 10 and, where appropriate, to control the movement of the frame 10 on the ground.

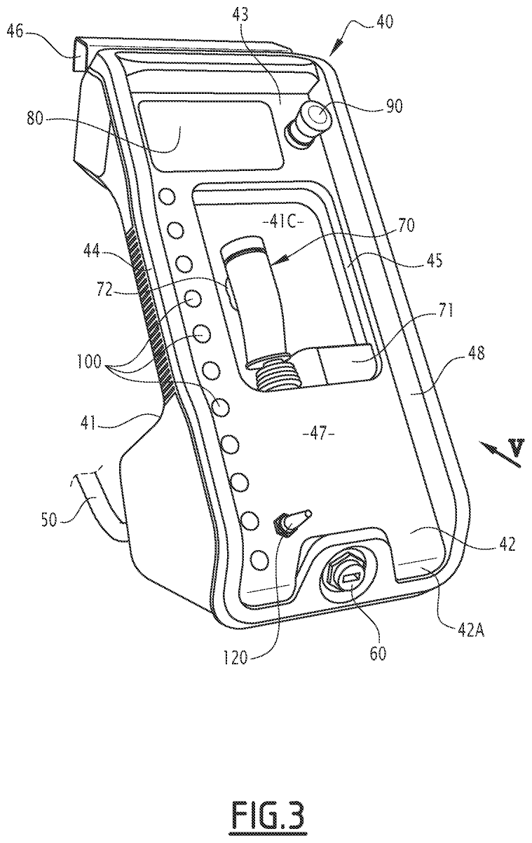

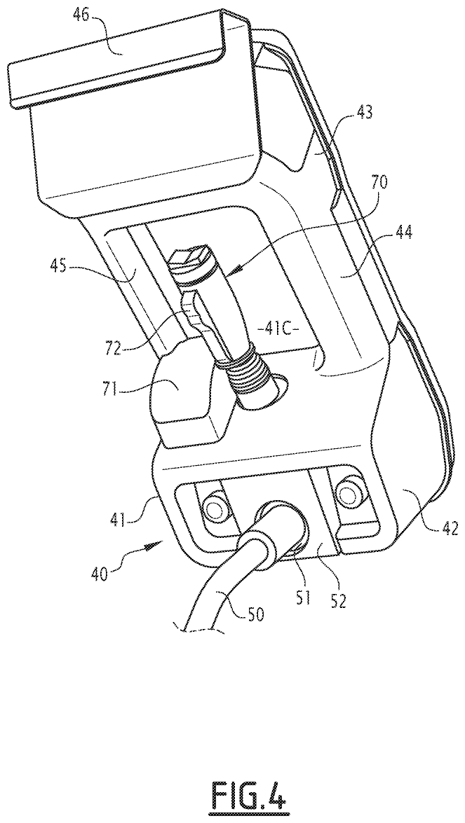

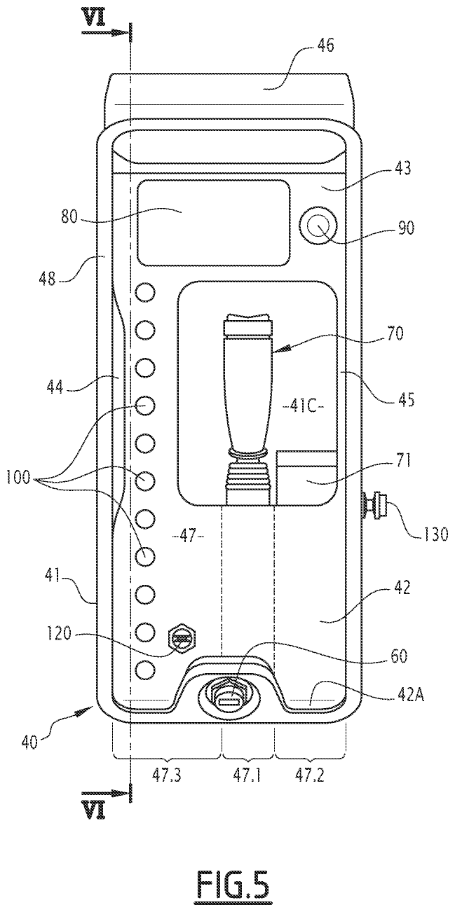

As can be seen clearly in FIGS. 2 to 6, the console 40 includes a main body 41 which has two faces opposite each other, namely a front face 41A and a rear face 41B. Thereby, the front and rear faces 41A and 41B are opposite each other along an anteroposterior direction of the main body 41. The front face 41A of the main body 41 is provided for being turned towards the operator when the console 40 is in service, i.e. when the operator uses the console for the purposes of controlling the aerial lift 1, as in FIG. 2. The front face 41A is turned towards the reader in FIGS. 3 and 5, whereas the rear face 41B is turned towards the reader in FIG. 4.

The main body 41 includes two crosspieces and two uprights, namely a lower crosspiece 42 and an upper crosspiece 43, and a left-hand upright 44 and a right-hand upright 45. The lower 42 and upper 43 crosspieces each extend throughout the width of the main body 41, the lower crosspiece 42 being located under the upper crosspiece 43 when the console 40 is in use. The left-hand 44 and right-hand 45 uprights each extend throughout the height of the main body 41 and, when the console 40 is in use, are located respectively to the left and to the right of the console when the latter is observed from the front face 41A of the main body 41 thereof, as in FIG. 5. The lower crosspiece 42 connects the respective lower end portions of the left-hand 44 and right-hand 45 uprights to each other. The left-hand upright 44 connects the respective left-hand end portions of the lower 42 and upper 43 crosspieces to each other. The upper crosspiece 43 connects the respective upper end portions of the left-hand 44 and right-hand 45 uprights to each other. The right-hand upright 45 connects the respective right-hand end portions of the lower 42 and upper 43 crosspieces to each other.

Thereby, the lower crosspiece 42 and the left-hand upright 44 share the same left-hand lower part of the main body 41, the left-hand lower part corresponding to both the left-hand end part of the lower crosspiece 42 and the lower end part of the left-hand upright 44. Similarly, the left-hand upright 44 and the upper crosspiece 43 share the same left-hand upper part of the main body 41, the left-hand upper part corresponding to both the upper end portion of the left-hand upright 44 and the left-hand end portion of the upper crosspiece 43; the upper crosspiece 43 and the right-hand upright 45 share the same right-hand upper part of the main body 41, the right-hand upper part corresponding to both the right-hand end part of the upper crosspiece 43 and the upper end part of the right-hand upright 45; and the right-hand upright 45 and the lower crosspiece 42 share the same right-hand lower part of the main body 41, the right-hand lower part corresponding to both the lower end part of the right-hand upright 45 and the right-hand end part of the lower crosspiece 42.

The crosspieces 42 and 43 and the uprights 44 and 45 delimit therebetween a through-passage 41C which connects the front face 41A and the rear face 41B of the main body 41 to each other. The through-passage 41C is open at the two opposite ends thereof along the anteroposterior direction of the main body 41, coming out onto the front face 41A and the rear face 41B. Along a direction peripheral to the anteroposterior direction of the main body 41, the through-passage 41C is closed by the crosspieces 42 and 43 and the uprights 44 and 45. The corresponding closed contour of the through-passage 41C extends over 360°, as can be seen clearly in FIG. 5. In the example considered herein, the closed contour is overall rectangular, with rounded corners.

The console 40 is designed for being attached to the platform 20, in particular to the guardrail 22 of the latter. In the embodiment considered in the figures, the console 40 is designed for being attached to the platform 20 in a removable manner. To this end, the console 40 includes a hook 46 for attaching the console 40 in a removable manner to the guardrail 22 of the platform 20. As can be seen clearly in FIGS. 2, 4 and 6, the hook 46 is arranged on the rear face 41B of the main body 41, preferentially at the upper crosspiece 43 of the main body 41. The hook 46 is shaped so as to cooperate by matching shape with an upper bar 22.1 of the guardrail 22, extending parallel to the floor 21 of the platform 20. In practice, the hook 46 can advantageously have different sizes in order to adapt to various possible dimensions for the components of the guardrail 22.

When the console 40 is detached from the platform 20, the console can be deactivated for storage purposes. The console 40 can also be kept activated and used for controlling the aerial lift 1: in such case, the operator holds the console 40 in his/her hand and, for this purpose, the left-hand upright 44 is advantageously shaped as a handle for the left hand of the operator.

Moreover, the console 40 is designed for being connected to the control unit 13 of the aerial lift 1 which, as shown diagrammatically in FIG. 1, is preferentially integrated into the chassis 10. The control unit 13 comprises e.g. a microprocessor and is designed for actuating, depending on the commands issued by the control elements belonging to the console 40, the drive elements which ensure the driving of the lifting structure 30 with respect to the chassis 10 and, where appropriate, actuating the motorization which provides the movement of the chassis 10 on the ground. In the embodiment considered in the figures, the corresponding connection between the control console 40 and the control unit 13 is made by a cable 50, of which only the end connected to the console 40 is visible in the figures. The cable 50 is used for transmitting to the control unit 13 the commands issued by the control elements belonging to the console 40. The cable 50 can also provide electrical power to the console 40. The electrical energy supplied by the cable 50 can be consumed directly or stored in a battery integrated into the console 40.

It is advantageously provided that a cable 50 exits from the rear face 41B of the main body 41, in particular for ergonomic reasons. That said, in a variant (not shown) the cable 50 exits downwards from the lower end of the lower crosspiece 42.

According to a practical embodiment, the cable 50 can be connected in a removable manner to the console 40: the console 40 then integrates, more particularly into the lower crosspiece 42 thereof, a connection socket 51 which is accessible from the rear face 41B of the main body 41 for the purpose of connecting the cable 50. In the example of embodiment considered in the figures, the connection socket 51 is advantageously protected by a plate 52 which is directly mounted onto the rear face 41B of the main body 41 so as to lock the connection socket 51 and thereby prevent the disassembly or tinkering of the latter, in particular for safety purposes.

According to an advantageous optional arrangement, which is used in the embodiment considered in the figures, a lower edge 42A of the lower crosspiece 42 of the main body 41 is provided with a connection port 60, such as a USB port, which is accessible from the front face 41A of the main body 41. The purpose of the connection port 60 is not limiting, but is intended, in all cases, for improving the practicality of the console 40. As an example, the connection port 60 allows a mobile electronic device, such as a telephone, to be connected for being charged. The connection port 60 can also be used for connecting a mobile terminal in order to exchange data between the latter and the console 40, e.g. for the purposes of monitoring, updating, troubleshooting, etc.

The console 40 further includes a joystick 70 which forms one of the manually operated control elements belonging to the console. As can be seen clearly in FIGS. 2 to 6, the joystick 70 is arranged inside the through-passage 41C of the main body 41, extending upwards from the lower crosspiece 42. The joystick 70 is mounted on the lower crosspiece 42 so as to be displaceable, in particular tiltable, from a rest position which the joystick 70 occupies when same is at rest, i.e. in the absence of any force applied thereto, in particular by the operator.

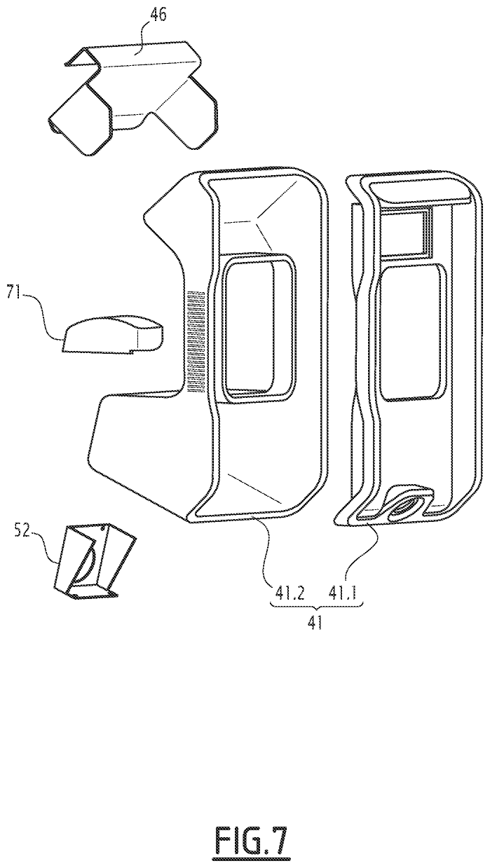

When the console 40 is in operation, the joystick 70 is designed to be gripped by the right hand of the operator, as shown schematically in FIG. 2: the carpal region of the right hand is then located between the joystick 70 and the right-hand upright 45 of the main body 41, while the fingers of the right hand are closed around the joystick 70 and the right arm of the operator emerges from the through-passage 41C through the front face 41A of the main body 41. According to an advantageous optional arrangement, which is implemented in the embodiment considered in the figures, the console 40 further includes a wrist rest 71 for the right hand of the operator holding the joystick 70, the wrist rest 71 being arranged in the lower right-hand corner of the through-passage 41C, as can be seen clearly in FIGS. 3 to 5. In practice, the embodiment of the wrist rest 71 is not limiting: in the example envisaged in the figures, the wrist rest 71 is a directly mounted part, as illustrated in FIG. 7, which is rigidly attached to the main body 41 by any appropriate means.

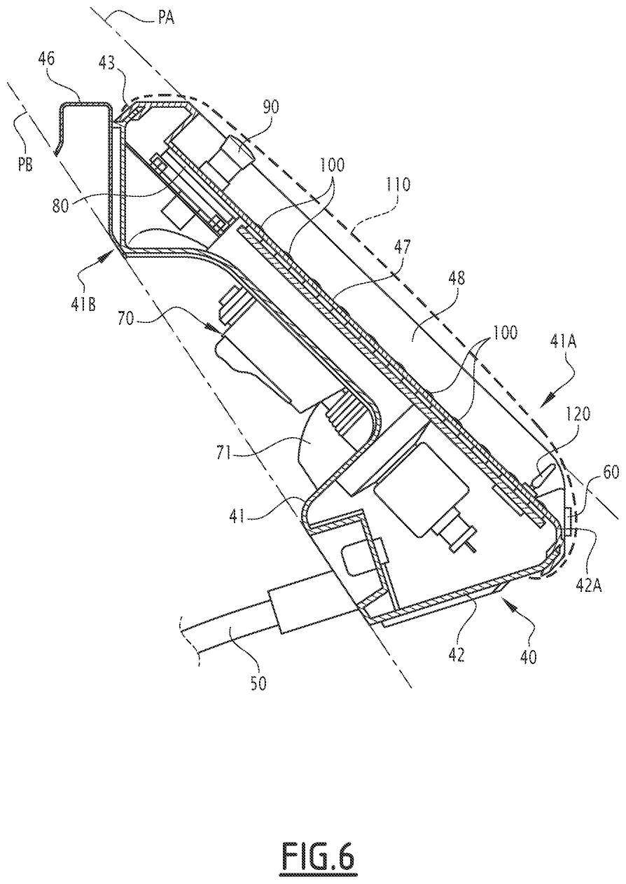

When the console 40 is in use, in particular when the console is attached to the platform 20, the joystick in the rest position is tilted backwards from bottom up, as can be seen clearly in FIGS. 2 and 6. The backward tilt contributes to the effective and comfortable use of the console 40. The tilt is preferentially such that, when the console 40 is in use, more particularly attached to the platform 20 while the floor 21 of the latter is horizontal, the joystick 70 in the rest position is tilted at 45°, plus or minus 5°, from the vertical. The tilt range increases the operator's ease of use of the console 40. Also for the purpose of improving the efficient and safe use of the console 40, the center 70A of the joystick 70, i.e. the region of the latter which is gripped in the palm of the right hand of the operator, is located at a distance D from the floor 21 of the platform 20, which is advantageously comprised between 91 and 95 cm, as illustrated schematically in FIG. 2: in this way, in use, the operator, who stands on the floor 21 and who holds the joystick 70 in his/her right hand, has his/her right arm which forms an obtuse angle at his/her elbow, which corresponds to a satisfactory position in terms of efficient and safe use for the operator, compared to a situation where the latter would have to bend his/her arm at a right angle.

In practice, the embodiment of the joystick 70 is not limiting as long as the latter can be gripped by the right hand of the operator, as described hereinabove, and the displacement, by the operator, of the joystick 70 from the rest position thereof generates a command for controlling the aerial lift 1, more particularly for actuating the aerial lift 30. Thereby, multiple embodiments can be envisaged for the joystick 70, where the latter can integrate one or a plurality of buttons, the manual actuation of which modifies the command generated by the movement of the joystick 70. More particularly, for safety reasons, one of the buttons preferentially forms a validation element 72, called the “dead man button”, so that a movement ordered by displacement of the joystick 70 is executed only if the validation element 72 is actuated simultaneously.

The rearward inclination of the joystick 70 in the rest position is advantageously used for increasing the safety of use of the aerial lift 1, by providing that the joystick 70 is designed for raising the platform 20 when the joystick is tilted forwards from the rest position thereof and lowering the platform 20 when the joystick is tilted backwards from the rest position thereof. Thereby, in the event of the operator being crushed against the console 40 by an external obstacle, such as part of a building or a branch of a tree, striking the operator from behind or from above, the operator is pushed in the direction of the joystick 70, which tends to tilt the latter backwards and thus to lower the platform 20.

As can be seen clearly in FIGS. 3, 5 and 7, the front face 41A of the main body 41 includes a flat face 47, onto which the through-passage 41C comes out and which extends continuously both over the lower crosspiece 42, over the left-hand upright 44 and over the upper crosspiece 43. Thereby, the lower 42 and upper 43 crosspieces and the left-hand upright 44 have, on the front face 41A of the main body 41, respective surfaces which, together, form the flat surface 47 and which are all inscribed in the same plane, by connecting directly to one another without discontinuity, as can be seen clearly in FIG. 6. When the console 40 is in use, more particularly when the console is attached to the platform 20, the flat surface 47 is tilted backwards from bottom up. In the example of embodiment considered in the figures, the flat surface 47 is thereby tilted parallel to the joystick 70 in the rest position. In all cases, the rearward tilt of the flat surface 47 makes it possible to orient the latter towards the operator holding the joystick 70, while making it possible to position the console 40 in a lower portion of the operator's field of vision, which is particularly comfortable, effective and practical. Indeed, the console 40, thereby positioned relatively low with respect to the operator, limits only marginally the field of vision of the latter, while keeping the flat surface 47 oriented directly towards the operator, in particular, as explained hereinafter, for the purpose of observing the flat surface 47 and of actuating control elements supported by the flat surface 47.

On the upper crosspiece 43 of the main body 41, the flat surface 47 is provided with a display 80. The display 80 is in particular provided for transmitting visual information to the operator. The display 80 thereby improves the taking over of the console 40 by the operator, by facilitating the understanding of the latter during the operation of the console, and also makes a control possible during use. In practice, the embodiment of the display 80 is not limiting. As an example, the display 80 comprises an electronic screen, protected by a transparent cover plate.

Also on the upper crosspiece 43, the flat surface 47 is advantageously provided with an emergency stop button 90, which is known per se and the actuation of which cuts off the power to the aerial lift 1. The emergency stop button 90 is advantageously located to the right of the display 80, for a comfortable, effective use when actuated by the right hand of the operator.

On the left-hand upright 44 of the main body 41, the flat surface 47 is provided with push-buttons 100, which correspond to some of the manually actuated control elements belonging to the console 40. The actuation of each of the push-buttons 100 leads to activating/deactivating a predetermined function in connection with the control of the aerial lift 1, such technical aspect being known per se in the field and hence not being described in greater detail herein. The arrangement of the push-buttons 100 on the flat surface 47 at the left-hand upright 44 is particularly practical, comfortable, and effective, in particular by making the actuation of the push-buttons 100 by the left hand of the operator possible when the latter is holding the joystick 70 using his/her right hand, including when the left hand of the operator holds the left-hand upright 44 since the user can then use his/her left thumb for actuating at least some of the push-buttons 100. In such context, all or some of the push-buttons 100 are advantageously distributed along the left-hand upright 44, as in the example illustrated in the figures.

In practice, the embodiment of the push-buttons 100 is not limiting. As an example, which is moreover used in the embodiment illustrated, the push-buttons 100 are flat push-buttons. Optionally, the push-buttons 100 incorporate a luminous return function, which illuminates the push-button when the latter is activated.

On the lower crosspiece 42 of the main body 41, the flat surface 47 runs from the through-passage 41C to the lower edge 42A of the lower crosspiece 42, which is set back with respect to the flat surface 47, as can be seen clearly in FIGS. 3 and 6. The lower edge 42A thus does not protrude with respect to the flat surface 47. There, water or dirt does not accumulate on the flat surface 47 because, due to the tilt of the flat surface, water, such as rainwater, falling on the flat surface 47 tends to flow therefrom by gravity as far as the lower edge 42A where the water is freely discharged outside the console 40, in particular without being retained by the lower edge 42A, due to the arrangement of the latter, set back from the flat surface 47. In the example of embodiment considered in the figures, the lower edge 42A is not set back with respect to the flat surface 47 over the entire extent of the lower edge between the left-hand upright 44 and right-hand upright 45 of the main body 41, but is thereby set back to the left and to the right of a localized bulge of the lower edge 42A, where the connection port 60 is arranged. The water flowing over the flat surface 47 discharges therefrom at the lower edge 42A by flowing on both sides of the bulge.

On the lower crosspiece 42, the flat surface 47 is divided into three regions which are marked in FIG. 5, namely a first region 47.1 which is situated in vertical alignment with the joystick 70, a second region 47.2 which connects the first region 47.1 to the right-hand upright 45 of the main body 41, and a third region 47.3 which connects the first region 47.1 to the left-hand upright 44. The first and the second regions 47.1 and 47.2 are advantageously devoid of any control element: in this way, the right arm of the operator, whose right hand holds the joystick 70, does not hinder nor hide control elements which would have been provided in one and/or the other of the regions 47.1 and 47.2 of the flat surface 47. On the other hand, the third region 47.3 of the flat surface 47 is not in line with the right arm of the operator and can thus support control elements, in the present case, in the embodiment considered herein, some of the push-buttons 100.

According to an advantageous optional arrangement which is used in the example considered in the figures, the front face 41A of the main body 41 has a rim 48 which protrudes from the flat surface 47 and runs over part of the periphery of the flat surface, so that the forward-facing edge of the rim 48 defines a forward support plane PA, set back from which are arranged, the joystick 70 in the rest position and the push-buttons 100, as can be seen clearly in FIG. 6. In the example of embodiment considered herein, the rim 48 runs over the entire periphery of the flat surface 47, except over the lower edge 42A of the lower crosspiece 42. In all cases, the rim 48 protects the flat surface 47 and the elements the flat surface supports, in the sense that the front support plane PA geometrically defined by the front edge of the rim 48 prevents an external obstacle extending across the face 41A from interfering with the flat surface 47, by being held in abutment against the front support plane PA. Such a situation is encountered e.g. in the case where the console 40 falls to the ground, on the front face 41A thereof. Where appropriate, only the top of the emergency stop button 90 can be arranged protruding from the front support plane PA, as in the example envisaged in the figures: in such case, only the activation of the emergency stop button 90 is possible in the event of the console 40 falling on the front face 41A thereof or, more generally, in the event of interference between the front face 41A and an obstacle extending across the latter.

According to considerations similar to the considerations developed hereinabove in connection with the front support plane PA, the rear face 41B of the main body 41 advantageously defines a rear support plane PB, set back from which the joystick 70 is arranged in the rest position, as can be seen clearly in FIG. 6. In the embodiment considered herein, the rear support plane PB is defined by the rear of the lower crosspiece 42 and upper crosspiece 43.

According to another advantageous optional arrangement, which is illustrated schematically only in FIG. 6, the console 40 includes a flexible protective cover 110, e.g. made of an extensible plastic material. This protective cover 110 is suitable for covering in a removable manner, at least the flat surface 47, or even the entire front face 41A of the main body 41, as indicated by dashed lines in FIG. 6. The protective cover 110 thereby protects the flat surface 47, or even the entire front face 41A, from rain and, more generally, from bad weather and external conditions. The protective cover 110 is made to be transparent at least in the part thereof which covers the display 80 when the protective cover 110 covers the flat surface 47.

According to a practical embodiment, the protective cover 110 is permanently attached to one of the lower 42 and upper 43 crosspieces and can be extended to the other of the lower 42 and upper 43 crosspieces, with which the protective cover cooperates to be reversibly retained, by any appropriate means. As an option (not shown), a winder is provided on the crosspiece to which the protective cover 110 is permanently attached, so that the latter is wound around the winder when the cover does not cover the flat surface 47. As an alternative variant, the protective cover 110 forms a case that is completely removable from the main body 41.

In a variant (not shown) of the protective cover 110, the console 40 comprises a protective cover, at least partially rigid, which covers in a removable manner at least the flat surface 47, or even the entire front face 41A of the main body 41. In particular, the cover can be formed either as one part, separable or mounted so as to be movable with respect to the main body 41, or formed of several parts, retractable with respect to one another.

Finally, various arrangements and variants of the console 40 and of the aerial lift 1, which have been described up to now, can be envisaged. As examples, we list hereinafter are various corresponding aspects, which can be considered alone together with the foregoing or in combination with each other:
In addition to the push-buttons 110, the flat surface 47 can be provided with one or a plurality of rocker buttons, more particularly on the left-hand upright 44. Thereby, in the example of embodiment considered in the figures, the console 40 is thus provided with a rocker button 120, which is located in the region 47.3 of the flat surface 47 and the holding of which in operation, in particular by the left hand of the operator, controls the driving of the lifting structure 30 by the joystick 70 at a higher speed than when the push-button 120 is released.
The console 40 is compatible with the protection device disclosed in WO 2020/144601. To this end, in the example of embodiment shown in the figures, the console 40 is provided, on the right flank thereof, with a coupling element 130 for coupling to the protection device, the coupling element 130 being visible in FIG. 5. Of course, the specific features, in particular shape and dimensions, of the coupling element 130 are not limited to the features visible in FIG. 3.
The main body 41 of the console 40 can be made by assembling two one-piece shells 41.1 and 41.2, in particular of plastic material, which are superposed one on the other along the anteroposterior direction of the main body 41, as illustrated schematically in FIG. 7. The main body 41 is then easy to mount/dismount, while sealing the inside of the main body in a simple and reliable way.
The wired connection between the control console 40 and the control unit 13, which is provided by the cable 50 in the example embodiment considered hitherto, can be replaced by a non-wired connection.
Rather than being attached to the platform 20 in a removable manner, the console 40 can be permanently attached thereto.
Rather than being self-propelled, the aerial lift 1 can be without motorization for being moving on the ground. In such case, to be moved on the ground, the aerial lift is pulled or pushed.
The aerial lift 1 considered so far is only one example of a personnel-lifting machine to which the invention is applicable. Thereby, in variants of the aerial lift 1, the personnel-lifting machine can be a machine arranged stationary with respect to the ground, or else a machine on board a motor vehicle, such as a truck, without any possibility of controlling the motion of the vehicle on the ground from the platform 20 of the machine.
The console 40 can have a plurality of sizes, in particular depending on the type and size of the personnel-lifting machine controlled by the console. More particularly, in addition to the joystick 70 and push-buttons 100, the console can then integrate other control elements, such as one or a plurality of additional joysticks, additional push-buttons, one or a plurality of rocker buttons, etc.

1. A vibration signal generation device that generates a vibration signal for vibrating a vibration generation device while a piece of music is being played, the vibration signal generation device comprising:
a mode determination unit that determines a mode from a plurality of modes;
an extraction unit that extracts, from the audio signal of the piece of music, the audio signal in the band corresponding to the mode determined by the mode determination unit; and
a generation unit that generates the vibration signal based on the audio signal extracted by the extraction unit, wherein
the plurality of modes include a first mode for a relaxation effect,
the extraction unit extracts, when the determined mode is the first mode, an audio signal in a first band from the audio signal of the piece of music, and
at least part of the first band has a frequency below a band for another mode.

2. (canceled)

3. The vibration signal generation device according to claim 1, wherein
the vibration generation device is embedded in a seat on which a user can sit,
the vibration generation device includes a first vibration generation device embedded in a part facing the back of the user seated on the seat, and a second vibration generation device embedded in a part facing the waist of the user seated on the seat,
the vibration signal includes a first vibration signal for vibrating the first vibration generation device and a second vibration signal for vibrating the second vibration generation device, and
the first band for the second vibration signal is narrower than the first band for the first vibration signal.

4. The vibration signal generation device according to claim 1, wherein
the vibration generation device is embedded in a seat on which a user can sit,
the vibration generation device includes a first vibration generation device embedded in a part facing the back of the user seated on the seat, and a second vibration generation device embedded in a part facing the waist of the user seated on the seat,
the vibration signal includes a first vibration signal for vibrating the first vibration generation device and a second vibration signal for vibrating the second vibration generation device, and
when the determined mode is the first mode, the generation unit generates the first and second vibration signals so that the intensity of vibration generated by the first vibration generation device is higher than the intensity of vibration generated by the second vibration generation device.

5. The vibration signal generation device according to claim 1, wherein
the plurality of modes further include a second mode for an awakening effect,
when the determined mode is the second mode, the extraction unit extracts an audio signal in a second band from the audio signal of the piece of music, and
at least part of the second band has a frequency above a band for another mode.

6. The vibration signal generation device according to claim 5, wherein
the vibration generation device is embedded in a seat on which a user can sit,
the vibration generation device includes a first vibration generation device embedded in a part facing the back of the user seated on the seat, and a second vibration generation device embedded in a part facing the waist of the user seated on the seat,
the vibration signal includes a first vibration signal for vibrating the first vibration generation device and a second vibration signal for vibrating the second vibration generation device, and
when the determined mode is the second mode, the generation unit generates the first and second vibration signals so that the intensity of vibration generated by the second vibration generation device is higher than the intensity of vibration generated by the first vibration generation device.

7. The vibration signal generation device according to claim 1, wherein
the plurality of modes include a second mode for an awakening effect,
the extraction unit extracts, when the determined mode is the second mode, an audio signal in a second band from the audio signal of the piece of music, and
at least part of the second band has a frequency above the first band.

8. The vibration signal generation device according to claim 7, wherein
the vibration generation device is embedded in a seat on which a user can sit,
the vibration generation device includes a first vibration generation device embedded in a part facing the back of the user seated on the seat, and a second vibration generation device embedded in a part facing the waist of the user seated on the seat,
the vibration signal includes a first vibration signal for vibrating the first vibration generation device and a second vibration signal for vibrating the second vibration generation device, and
the generation unit generates the first and second vibration signals so that, when the determined mode is the first mode, the intensity of vibration generated by the first vibration generation device is higher than the intensity of vibration generated by the second vibration generation device, and when the determined mode is the second mode, the intensity of vibration generated by the second vibration generation device is higher than the intensity of vibration generated by the first vibration generation device.

9. The vibration signal generation device according to claim 1, wherein the vibration generation device is embedded in a seat on which a user can sit.

10. The vibration signal generation device according to claim 1, further comprising a biometric signal acquisition unit that acquires biometric information of a user seated on the seat,
wherein the mode determination unit determines the mode based on the acquired biometric information.

11. A vibration signal generation method executed by a computer to generate a vibration signal for vibrating a vibration generation device while a piece of music is being played, the vibration signal generation method comprising:
a mode determination step of determining a mode from a plurality of modes;
an extraction step of extracting, from the audio signal of the piece of music, the audio signal in the band corresponding to the mode determined by the mode determination step; and
a generation step of generating the vibration signal based on the audio signal extracted by the extraction step, wherein
the plurality of modes include a first mode for a relaxation effect,
in the extraction step, when the determined mode is the first mode, an audio signal in a first band is extracted from the audio signal of the piece of music, and
at least part of the first band has a frequency below a band for another mode.

12. A non-transitory computer-readable medium on which is stored a vibration signal generation program that causes a computer to execute the vibration signal generation method according to claim 11 when the program is executed by the computer.

13. (canceled)

14. The vibration signal generation device according to claim 5, wherein the vibration generation device is embedded in a seat on which a user can sit.

15. The vibration signal generation device according to claim 7, wherein the vibration generation device is embedded in a seat on which a user can sit.

16. The vibration signal generation device according to claim 3, further comprising a biometric signal acquisition unit that acquires biometric information of a user seated on the seat,
wherein the mode determination unit determines the mode based on the acquired biometric information.

17. The vibration signal generation device according to claim 4, further comprising a biometric signal acquisition unit that acquires biometric information of a user seated on the seat,
wherein the mode determination unit determines the mode based on the acquired biometric information.

18. The vibration signal generation device according to claim 6, further comprising a biometric signal acquisition unit that acquires biometric information of a user seated on the seat,
wherein the mode determination unit determines the mode based on the acquired biometric information.

19. The vibration signal generation device according to claim 9, further comprising a biometric signal acquisition unit that acquires biometric information of a user seated on the seat,
wherein the mode determination unit determines the mode based on the acquired biometric information.

20. The vibration signal generation device according to claim 14, further comprising a biometric signal acquisition unit that acquires biometric information of a user seated on the seat,
wherein the mode determination unit determines the mode based on the acquired biometric information.

21. The vibration signal generation device according to claim 15, further comprising a biometric signal acquisition unit that acquires biometric information of a user seated on the seat,
wherein the mode determination unit determines the mode based on the acquired biometric information.
